(19) United States
(12) Patent Application Publication
(10) Pub. No.: US 2018/0037051 A1
(43) Pub. Date: Feb. 8, 2018

(54) Non-Porous Thermofoil Decorative Object and a Method For Thermoforming a Non-Porous Substrate

(71) Applicant: Vertical Illusion, LLC, Phoenix, AZ (US)

(72) Inventors: Michael Cordovana, Phoenix, AZ (US); Thomas Cashman, Phoenix, AZ (US)

(21) Appl. No.: 15/352,867

(22) Filed: Nov. 16, 2016

Related U.S. Application Data
(60) Provisional application No. 62/371,871, filed on Aug. 8, 2016.

(51) Int. Cl. B44C 1/20; B32B 3/26

(52) U.S. Cl. CPC B44C 1/20; B32B 3/266; B32B 2451/00

(57) ABSTRACT

Non-porous thermofoil decorative objects and a method for thermoforming such objects are disclosed herein. A preferred embodiment of the decorative object comprises a non-porous substrate and a thermofoil thermoformed to the substrate. The substrate of this embodiment has a top surface, a flat bottom surface, and an exhaust port extending from the top surface to and bottom surface. The thermofoil of this embodiment is thermoformed onto the top surface and the edges of the substrate and covers the exhaust port from the top. An exemplary exhaust port can be located at any location of the substrate, but if the top surface of the embodiment additionally has a steeply raised level, the exhaust port is preferably located at an edge of the raised level. A preferred diameter of the exhaust port is 1/32″-5/32″ and most preferably 3/32″.

### CROSS-REFERENCE TO RELATED APPLICATION

The present application claims priority to co-pending United States provisional patent application entitled “Thermofoil Decorative Object,” having Ser. No. 62/371,871, filed on Aug. 8, 2016, which is entirely incorporated herein by reference.

### BACKGROUND

Three-dimensional (3D) or textured decorative wall covers create additional dimension and charisma to a room that traditional painting and wallpapers lack. Existing decorative wall covers range from high-end, expensive commissioned wall arts, such as hand-sculpted wall mural, to more affordable wall tiles, and to even more reasonably priced wall panels. Common decorative wall panels include engineered wood boards, such as Medium-Density Fiberboard (MDF) panels, and cupboard panels that are painted or coated with thermofoil.

Thermofoil is a thin plastic material, such as Polyvinyl Chloride (PVC), thermoformed to a substrate, generally wood boards, as a surface finish. Thermofoil comes in various colors, texture, and sheen levels, such as high-gloss wood grain versions or metallic finishes. To start thermoforming, a substrate is generally sprayed with a two part heat activated glue that preferably comprises adhesive and hardener and placed on a pedestal or a pin system underneath a sheet of thermofoil. Then, the thermofoil is heated to a high-enough temperature and pressed to bond with the substrate, typically at its top surface and edges. Known methods for heating and pressing include bladder pressing, vacuum forming, and high pressure heated vacuum pressing with or without a membrane.

Compared to painting, thermoforming a wall panel is time saving and requires little labor, yet the result can look as good as, if not better than, a painted panel. Existing thermoforming techniques can only be applied to porous substrates because otherwise, during pressing, gas may be trapped between the thermofoil and a non-porous substrate and form air bubbles. Gas may also come from adhesives sprayed/applied on the substrate. If bubbles are formed, not only the result would not look as desired but the thermofoil may eventually peel. Commonly used porous substrates for wall panels are heavy and nonresistant to moisture and fire. In contrast, synthetic materials, such as polyurethane (PU) and thermoplastics, may be lightweight while resistant to moisture or flame, but these materials are non-porous and thus not ideal to be thermoformed.

Therefore, it is desirous to have decorative objects that are covered with thermofoil so that they are aesthetically pleasing, yet affordable.

It is also desirous to have thermofoil decorative objects that use lightweight and water/flame resistant non-porous materials as substrates.

### SUMMARY

The structure, overall operation and technical characteristics of the present invention will become apparent with the detailed description of preferred embodiments and the illustration of the related drawings as follows.

The invention is incorporated in a non-porous thermofoil decorative object and a methods for thermoforming a non-porous substrate. An embodiment of the decorative object comprises a non-porous substrate and a thermofoil thermoformed to the substrate. Exemplary materials of a non-porous substrate include metal, glass, and plastic, but a preferred non-porous substrate is made of lightweight, water resistant, and flame resistant materials, such as rigid polyurethane.

In various embodiments of the decorative object, the thermofoil may be made of different materials, such as Polyvinyl chloride (PVC) and Polycarbonate (PC) thermoplastics, and have various textures, colors, and sheen levels. An exemplary thermofoil may comprise additional decorative elements such as beads, metallic sprinkles, and so forth.

In the exemplary embodiment of the decorative object, the non-porous substrate has a top surface, a bottom surface, and at least one exhaust port extending from the top surface to the bottom surface. An exemplary thermofoil is preferably thermoformed to a non-porous substrate at its top surface and edges but not at the bottom surface. The opening of an exemplary exhaust port at the bottom surface is preferably not blocked so that bubble formation between the thermofoil and the top surface may be avoided during pressing and bonding, otherwise the thermofoil may eventually peel away. Furthermore, the at least one exhaust port of an embodiment is preferably strategically placed so that bubble formation is prevented by not trapping gas at all or allowing any gas trapped to eventually escape.

In a preferred embodiment of the decorative object, the top surface of the substrate is contoured and/or textured to be aesthetically appealing, and the bottom surface is configured to attach to another object. For instance, an exemplary substrate may have a contoured top surface and a flat bottom surface so that the bottom surface can be affixed to a wall with adhesives or any other means.

In this embodiment, if the top surface further comprises a terraced surface, or other steeply raised level (such surfaces collectively referred to herein as a “steeply raised level”), the exhaust port is preferably located where gas can be trapped while thermoforming, such as at an edge of the raised level, or at any location where gas even if trapped may escape. If the top surface of the substrate in an alternate embodiment has more than one steeply raised levels, the substrate preferably has a plurality of exhaust ports each strategically placed as aforementioned to avoid or reduce trapped air.

In a preferred embodiment of the decorative object, the exhaust port of the substrate is configured to be big enough to avoid bubble formation from trapped gas but not too big that would cause a perceivable depression of the thermofoil after the thermofoil is pressed and bonded to the substrate. The diameter of an exemplary exhaust port is preferably in a range of 1/32″- 5/32″, most preferably 3/32″.

As to methods for thermoforming a non-porous object, a preferred embodiment comprises the steps of:
(1) Retrieving the non-porous object that has a top surface, a bottom surface, and an exhaust port extending from the top surface to the bottom surface;
(2) Retrieving a thermofoil; and
(3) Thermoforming the thermofoil to the top surface of the object with the thermofoil covering the exhaust port at the top surface.

A non-porous object used in various embodiments of the thermoforming method may have one or more features of the substrates in the embodiments of the decorative object as stated above. Similarly, a thermofoil used in an embodiment of the thermoforming method may incorporate at least one feature, such as the textures and colors, of the thermofoils illustrated above.

An embodiment of the thermoforming method may further include a step of piercing through the object to create the exhaust port. Another embodiment of the method may further comprise a step of molding to create the object with the exhaust port at a desired location. In another preferred embodiment, a glue may further be applied to the object on the top surface and any other sides of the object before the object is thermoformed, and the glue may comprise adhesives and hardener. An exemplary adhesive may be heat-activated or pressure-activated. A preferred embodiment may further include a step of sanding or rubbing the object to remove any imperfections on its surface(s). In an alternate embodiment of the thermoforming method, the thermofoil may be thermoformed onto only a portion, rather than the whole, of the top surface. Yet another embodiment of the thermoforming method may further comprise a step of trimming an unwanted portion of the thermofoil.

Additionally, an exemplary step for thermoforming the thermofoil to the top surface of the object, step 3 above, may include using any existing thermofoil pressing machines, such as Italpresse® thermofoil lamination presses or Black Bros.™ membrane & vacuum presses, or any thermoforming methods known in the art. An exemplary step for thermoforming the thermofoil to the object may include: (a) placing the object on a pedestal, a riser, or a pin system in a tray inside a chamber; (b) placing the pre-heated thermofoil over the object inside the chamber; (c) closing and sealing the chamber; and (d) drawing the heated thermofoil against the object by vacuum from below the thermofoil.

A preferred step for thermoforming the thermofoil to the object may include: (a) placing the object on a pedestal, a riser, or a pin system in a tray inside a chamber; (b) placing a thermofoil over the object; (c) closing and sealing the chamber; (d) drawing the thermofoil against an heated upper platen or any heat source above the thermofoil by vacuum above or air pressure below; (e) heating the thermofoil; (f) releasing the thermofoil from the upper platen or heat source; (g) drawing the heated thermofoil against the object by vacuum from below the thermofoil; and (h) applying positive air pressure from above the thermofoil for more detailed profile and bond strength.

An alternate preferred third step for thermoforming the thermofoil to the object may further include: (a) placing the object on a pedestal, a riser, or a pin system in a tray inside a chamber; (b) placing a thermofoil between a membrane and the object; (c) closing and sealing the chamber; (d) drawing the membrane and thermofoil against an heated upper platen or any heat source above the membrane by vacuum above or positive air pressure below; (e) heating the thermofoil by having the heat transferred from the platen or heat source, through the membrane, and then to the thermofoil; (f) releasing the membrane and the thermofoil from the platent or heat source; (g) drawing the heated membrane and thermofoil against the object by vacuum from below the thermofoil; (h) applying air pressure from above the membrane for added profile definition and bond strength between the thermofoil and the object; and (i) applying cold compressed air between the membrane and the thermofoil to separate them.

One object is to provide a lightweight, water/fire resistant, decorative object.

Another object is to provide a decorative object covered with thermofoil to be aesthetically appealing, yet affordable.

### BRIEF DESCRIPTION OF THE DRAWINGS OR PICTURES

FIG. 1 is a perspective view of an embodiment of the non-porous thermofoil decorative object.

FIG. 2 is a bottom plan view of the embodiment in FIG. 1.

FIG. 3 is a cross sectional view of the embodiment, along a virtual line 3-3, in FIG. 1.

FIG. 4 is the perspective view of the substrate of an alternate embodiment of the non-porous thermofoil decorative object.

FIG. 5 is the cross sectional view of another embodiment of the non-porous thermofoil decorative object.

FIG. 6 shows a wall partially covered with multiple embodiments of the non-porous thermofoil decorative object in FIG. 1.

### DESCRIPTION OF THE EMBODIMENTS

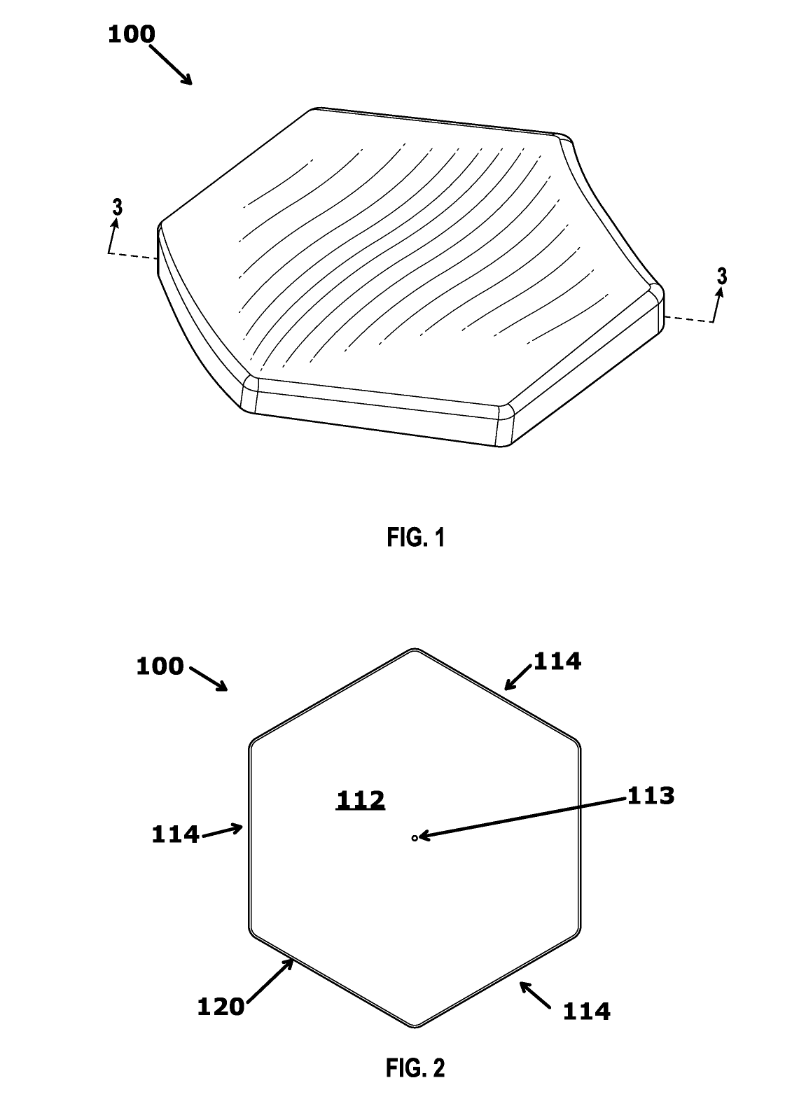

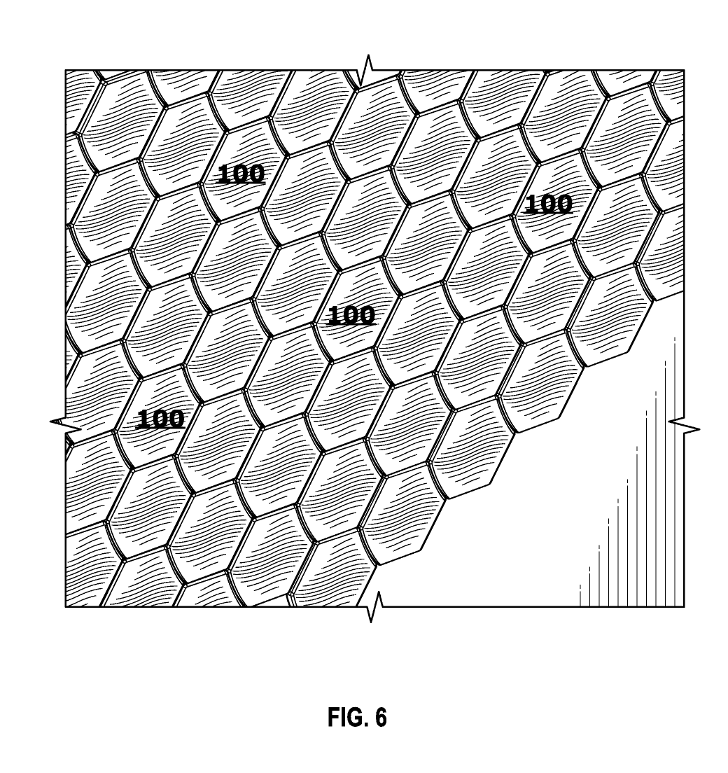

Exemplary embodiments of the thermofoil decorative object and/or portions thereof are shown in FIGS. 1-6. A preferred embodiment 100 is shown in FIGS. 1-3. This embodiment 100 has a non-porous substrate 110 and a thermofoil 120. The substrate 110 comprises a contoured top surface 111, a flat bottom surface 112, an exhaust port 113 extending from the top surface 111 to and bottom surface 112, and six edges 114. The thermofoil 120 preferably has an aesthetically appealing texture such as imitation wood grain and is thermoformed onto the top surface 111 and the edges 114. The exhaust port 113 is covered by the thermofoil 120 so that the exhaust port 113 is not seen from the top. In this preferred embodiment 100, the exhaust port 113 is located at the center of the substrate 110 and has a 3/32″ diameter. The preferred embodiment 100 may be displayed individually or attached to a wall with other similar embodiments, as in FIG. 6, to give the space a more dramatic focal point.

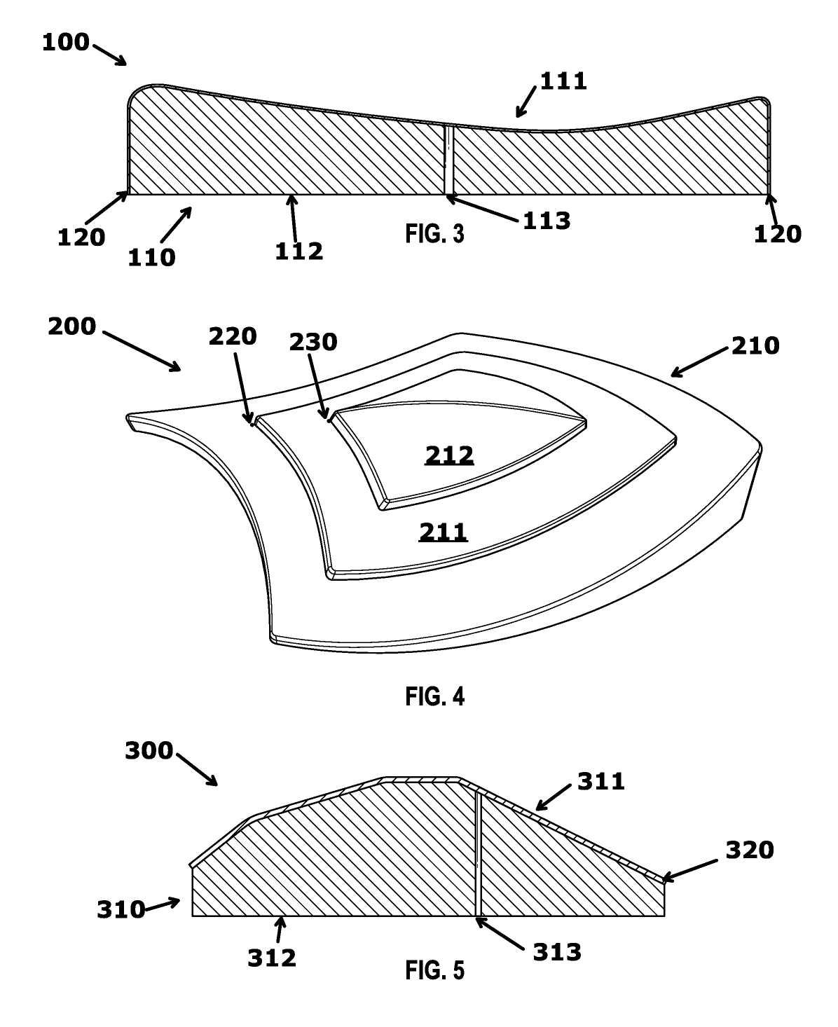

FIG. 4 shows a non-porous substrate 200 of another embodiment. This exemplary substrate 200 has a contoured top surface 210, a bottom surface (not shown), and two exhaust ports 220 and 230. The top surface 210 of this embodiment has two steeply raised levels 211 and 212. The exhaust ports 220 and 230 are preferably located at the edges of the raised levels 211 and 212 respectively.

FIG. 5 shows an alternate embodiment 300 that comprises a non-porous substrate 310 thermoformed with a thermofoil 320 only at the substrate's contoured top surface 311. The substrate 310 has an exhaust port 313 extending from the top surface 311 to the bottom surface 312 and located near a side of the substrate 310.

While the invention has been described by means of specific embodiments, numerous modifications and variations could be made thereto by those ordinarily skilled in the art without departing from the scope and spirit disclosed herein. For instance, a substrate of an embodiment may have different dimensions, profiles, and designs. An exemplary substrate may be a simple flat square block, a contoured polygon, a panel with multiple bumps on the top surface, and so forth. The substrates of different embodiments may have different numbers of exhaust ports at various locations and formed by different methods known in the art. The thermofoil in an embodiment may have various thickness, textures, colors, and sheen levels. Thermoforming a non-porous object in an embodiment may be done by any thermoforming methods known in the art. Therefore, the invention is intended to cover all techniques, devices, or structures known in the art and not be limited in scope except by the purview of the appended claims.

1. A decorative object comprising:
a. a non-porous substrate having:
i. a top surface,
ii. a bottom surface, and
iii. an exhaust port extending from the top surface to the bottom surface; and
b. a thermofoil thermoformed to the top surface of the substrate and covering the exhaust port.

2. The decorative object in claim 1, wherein the top surface is contoured.

3. The decorative object in claim 1, wherein when the top surface of the substrate further comprises a steeply raised level, the exhaust port is located at an edge of the raised level.

4. The decorative object in claim 1, wherein the exhaust port comprises a diameter in a range between 1/32″- 5/32″.

5. The decorative object in claim 1, wherein the substrate is lightweight, water resistant, and fire resistant.

6. The decorative object in claim 1, wherein the substrate is made of polyurethane.

7. The decorative object in claim 1, wherein the thermofoil is textured.

8. The decorative object in claim 1, wherein the bottom surface is configured to attach to another object.

9. The decorative object in claim 1, wherein the thermofoil is further thermofoiled to at least one edge of the substrate.

10. A method for thermoforming a non-porous object, the method comprising the steps of:
a. Retrieving the object, the object comprising:
i. a top surface,
ii. a bottom surface, and
iii. an exhaust port extending from the top surface to the bottom surface;
b. Retrieving a thermofoil; and
c. Thermoforming the thermofoil to the top surface of the object with the thermofoil covering the exhaust port.

11. The method in claim 10, wherein the top surface is contoured.

12. The method in claim 10, wherein when the top surface of the object further comprises a steeply raised level, the exhaust port is located at an edge of the raised level.

13. The method in claim 10, wherein the exhaust port comprises a diameter in a range between 1/32″- 5/32″.

14. The method in claim 10, wherein the object is lightweight, water resistant, and fire resistant.

15. The method in claim 10, wherein the object is made of polyurethane.

16. The method in claim 10, wherein the bottom surface is configured to attach to another object.

17. The method in claim 10 further comprises a step of trimming an unwanted portion of the thermofoil.

18. The method in claim 10, wherein the thermofoil is further thermoformed to at least one edge of the object.

19. A decorative object comprising:
a. a non-porous substrate having:
i. a top surface,
ii. a bottom surface configured to attach to another object, and
iii. at least one exhaust port with a diameter in a range between 1/32″- 5/32″ and extending from the top surface to the bottom surface;
and
b. a thermofoil thermoformed to the top surface of the substrate and covering the exhaust port.

20. The decorative object in claim 19, wherein when the top surface further comprises a steeply raised level, the exhaust port is located at an edge of the raised level.
